(19) United States
(12) Patent Application Publication
(10) Pub. No.: US 2025/0010650 A1
(43) Pub. Date: Jan. 9, 2025

(54) SELF-ADHESIVE FILM NOTEPAPER HOLDER

(71) Applicant: KUDOS FINDER TRADING CO., LTD., Taipei (TW)

(72) Inventor: JOUR CHAR-TER, Taipei (TW)

(21) Appl. No.: 18/340,012

(22) Filed: Jun. 22, 2023

(51) Int. Cl. B42D 5/00

(52) U.S. Cl. CPC B42D 5/00

(57) ABSTRACT

The present invention provides a self-adhesive film notepaper holder, which is a base body of various shapes (such as round and flat, square and flat, triangular and flat, or vehicle-shaped) made up of a first housing and a second housing of symmetric appearance. The relative inner sides of the first housing and the second housing are respectively configured with matching concave-hole columns and convex columns to form a base body. The base body has a novel appearance, and is convenient for carrying or putting on a desktop. It has a novel appearance, and is convenient for carrying or putting on a desktop. Inside the base body, one or more housing spaces are configured to hold corresponding sets of self-adhesive film notepaper, and corresponding openings are provided for drawing of the notepaper. When the self-adhesive film notepaper is used up, the base body can be separated to replace or replenish the self-adhesive film notepaper.

### BACKGROUND OF INVENTION

### 1. Field of the Invention

The present invention relates generally to a self-adhesive film notepaper holder, and more particularly to a flat base body of various shapes made up of a first housing and a second housing with symmetric appearance, for installation and usage of multiple notepaper holders.

### 2. Description of Related Art

Sticky notepaper is widely used as a memo of important things, a reminder or a record of frequent contacts. Common sticky notepaper is a stack of multiple pieces of paper, and on the same side of each piece, the portion adjacent to the edge is applied with some gum of appropriate viscosity for longer durability and repeated usage. Users will select different sizes or types of film notepaper according to their actual needs or preferences. The self-adhesive film notepaper set can be easily replenished by the user.

To use the sticky notepaper, the user just needs to tear one piece of paper and write on it. As it is very convenient, sticky notepaper is very popular. However, frequent users will find that, when tearing one piece of paper, it will not be easily separated from the whole stack of sticky notepaper. The user has to use one hand to press the sticky notepaper set, and use the other hand to tear one piece of notepaper. As the material of self-adhesive film notepaper is very thin, after one piece is separated, the next piece is still difficult to separate. The user has to undergo the same operations. Without a guiding device, it is hard for the user to tear one piece of notepaper to use. To solve the above problem, a film notepaper holder is developed to help separating the pieces of self-adhesive film notepaper. However, as the film notepaper holder must be easy to carry, appropriate space planning of the base body is necessary. Furthermore, it will be better if the holder can hold multiple sets of self-adhesive sticky notepaper. Therefore, it is an object of innovation for the manufacturers to seek both functionality and beauty of the base body apart from the structural space planning.

### SUMMARY OF THE INVENTION

The main object of the present invention is to provide a self-adhesive film notepaper holder of a novel appearance, convenient for carrying or putting on the desktop, and capable of holding various types of self-adhesive film notepaper. When one piece of notepaper is extracted, the next piece will be drawn out for continuous extraction and use.

To accomplish the above object, the present invention provides a self-adhesive film notepaper holder. The base body is a flat base body of various shapes made up of a first housing and a second housing, symmetrically configured. On the inner sides of the first housing and the second housing, and at the positions near the periphery, matching concave-hole columns and convex columns are respectively configured. Through the columns, the first housing and the second housing can be locked together to form a base body. The assembled base body has multiple housing spaces inside to fit multiple sets of self-adhesive film notepaper, and multiple openings are configured for each notepaper set for extraction of each piece of notepaper. After each piece of self-adhesive film notepaper is pulled out, it will bring out the next piece, and expose it out of the base body. After the self-adhesive film notepaper is used up, the base body can be separated to replace or replenish the self-adhesive film notepaper set.

The above mentioned first housing and second housing can be transparent or opaque.

The above mentioned base body can be a round and flat, square and flat, triangular and flat or vehicle-shaped self-adhesive film notepaper holder. The inside of the base body is separated into multiple housing spaces by separating walls, for holding multiple sets of bar-shaped self-adhesive film notepaper.

### BRIEF DESCRIPTION OF THE DRAWINGS

FIG. 1 is an exploded view of the round and flat self-adhesive film notepaper holder of the present invention.

FIG. 2 is a combined view of the round and flat self-adhesive film notepaper holder of the present invention.

FIG. 3 is an illustration of a second embodiment of the round and flat self-adhesive film notepaper holder of the present invention.

FIG. 4 is an exploded view of a third embodiment of the round and flat self-adhesive film notepaper holder of the present invention.

FIG. 5 is an illustration of a third embodiment of the round and flat self-adhesive film notepaper holder of the present invention.

FIG. 6 is an exploded view of the square and flat self-adhesive film notepaper holder of the present invention.

FIG. 7 is a combined view of the square and flat self-adhesive film notepaper holder of the present invention.

FIG. 8 is an exploded view of the triangular and flat self-adhesive film notepaper holder of the present invention.

FIG. 9 is a combined view of the triangular and flat self-adhesive film notepaper holder of the present invention.

FIG. 10 is an exploded view of the vehicle-shaped self-adhesive film notepaper holder of the present invention.

FIG. 11 is a combined view of the vehicle-shaped self-adhesive film notepaper holder of the present invention.

### DETAILED DESCRIPTION OF THE INVENTION

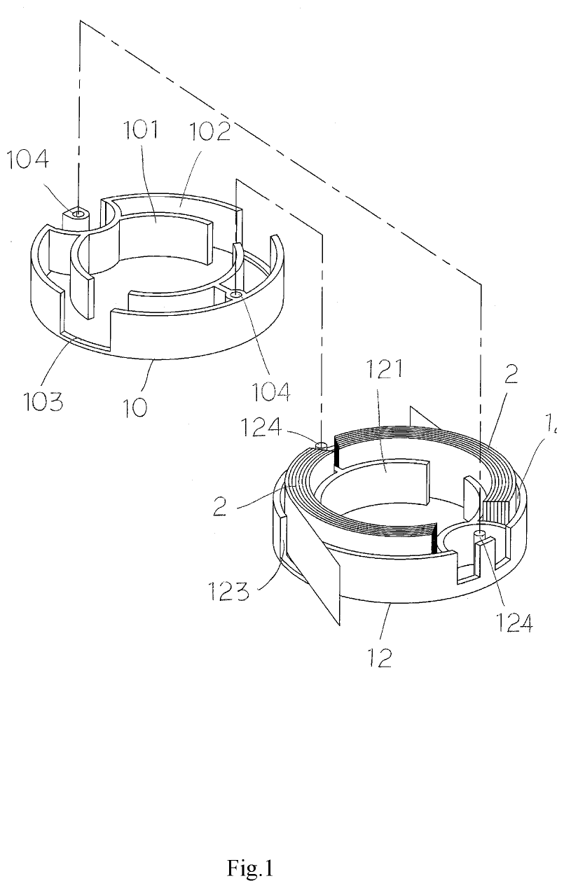

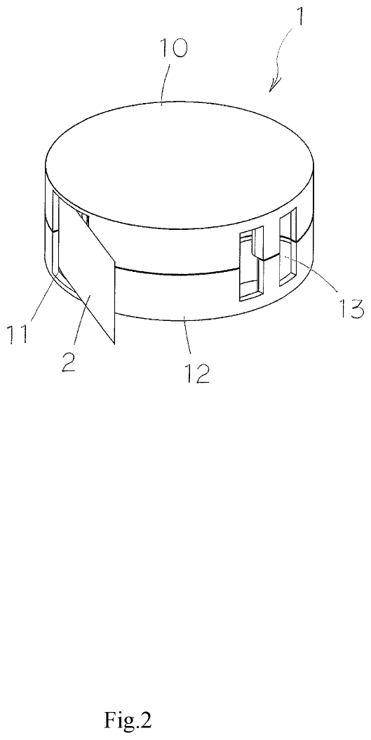

Referring to FIGS. 1˜2, an embodiment of the round and flat self-adhesive film notepaper holder of the present invention is illustrated. In order to hold multiple sets of self-adhesive film notepaper and to draw the notepaper when putting the notepaper holder on the desktop, the self-adhesive film notepaper holder of the present invention is designed to have a round and flat appearance. A first housing (10) and a second housing (12) of symmetric appearance are combined to make up a round and flat base body (1). The first housing (10) and the second housing (12) are round, transparent or opaque housings. The inner sides of the first housing (10) and the second housing (12) are separated into multiple housing spaces (102, 122) through symmetric separating walls (101, 121), to respectively hold multiple sets of bar-shaped self-adhesive film notepaper (2). Each set of bar-shaped self-adhesive film notepaper (2) corresponds to an opening (11) for respective extraction. The openings (11) are square and their quantity is the same as the number of self-adhesive film notepaper set (2), being respectively configured on the periphery of the base body (1). Each opening (11) is jointly formed by symmetric notches (103, 123) on the periphery of the first housing (10) and the second housing (12).

Below is a description of the assembly of the above round and flat base body (1). The relative inner sides of the first housing (10) and the second housing (12) adjacent to the periphery are respectively configured with two concave-hole columns (104) and two convex columns (124) matching each other, and the round and flat base body (1) is assembled by matching and locking the first housing (10) and the second housing (12); Moreover, the structures of the first housing (10) or the second housing (12) itself can be exchanged.

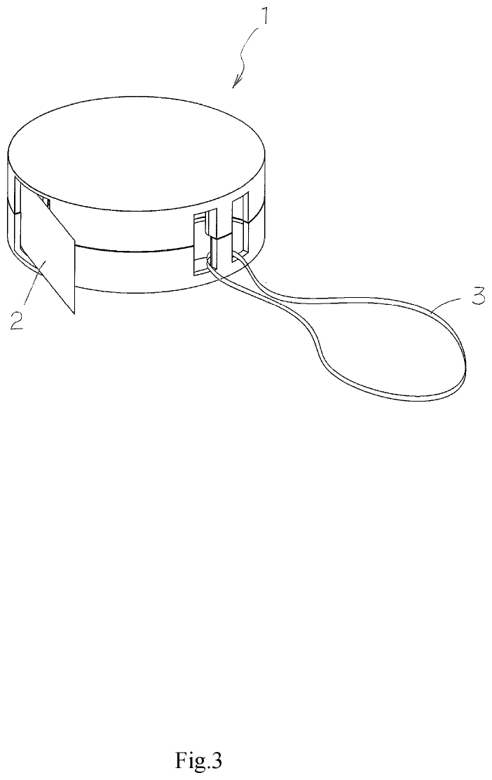

Referring to FIG. 3, when the above mentioned first housing (10) and the second housing (12) are combined, both sides of one set of concave-hole column (104) and convex column (124) are respectively formed with through-holes (13), to attach a rope (3).

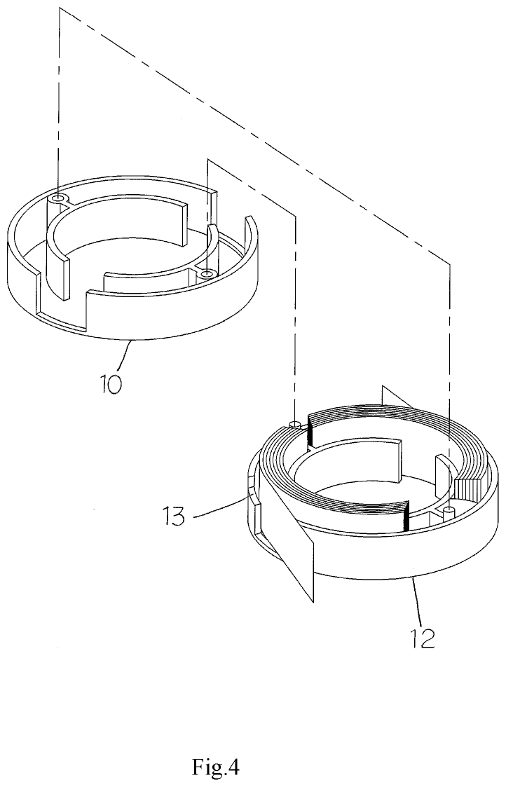

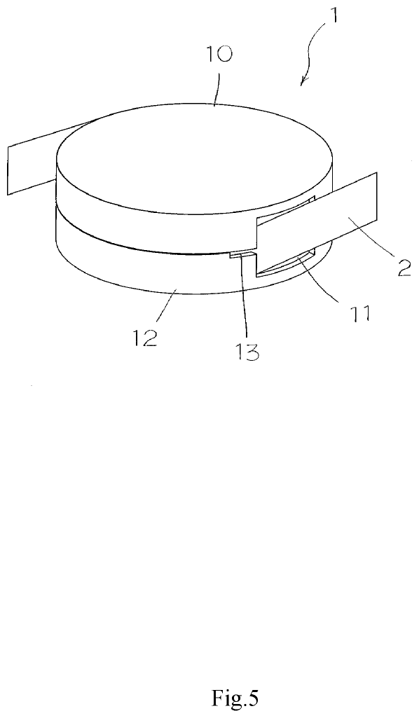

Referring to FIGS. 4˜5, apart from the configuration of through-holes to attach a rope (3) as mentioned above, a shallow gap (13) can be specially configured at an appropriate position on the periphery of the first housing (10) or the second housing (12) of the base body (1) of the present invention without the notches (103, 123); Thus, when the self-adhesive film notepaper set (2) is used up, the user can use his fingers of both hands to easily separate the base body from the shallow gap (13), and quickly replace or replenish the self-adhesive film notepaper set (2).

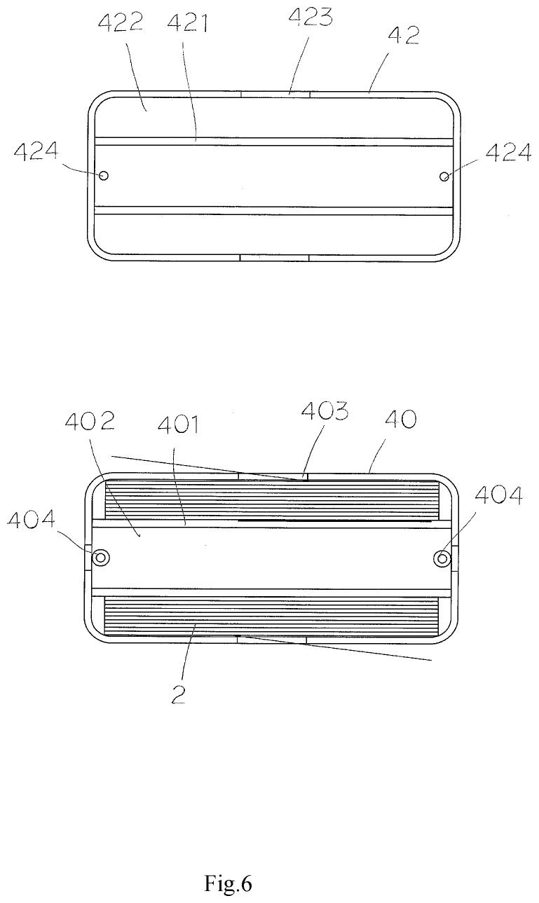

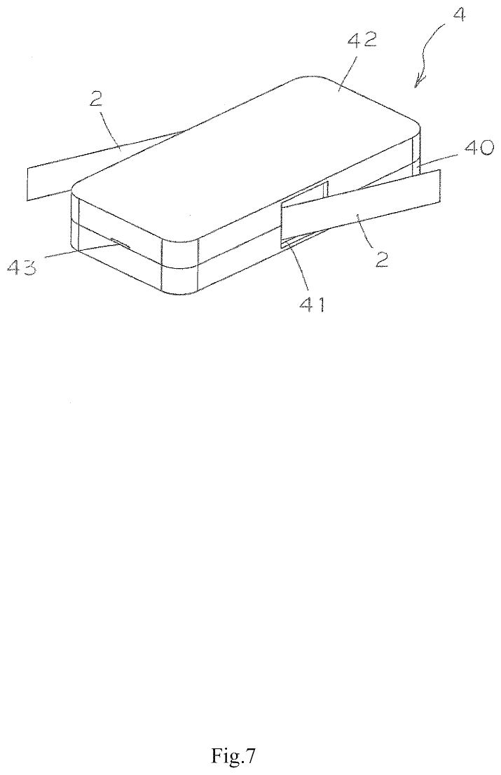

Referring to FIGS. 6˜7, another embodiment of a square self-adhesive film notepaper holder of the present invention is disclosed. Its appearance is a square and flat base body (4), made up of a combination of a square, transparent or opaque first housing (40) and a second housing (42), symmetrically configured. The inside of the first housing (40) and the second housing (42) are both partitioned into multiple housing spaces (402, 422) through separating walls (401, 421), to fit multiple sets of bar-shaped self-adhesive film notepaper (2). Each set of bar-shaped self-adhesive film notepaper (2) corresponds to an opening (41) for respective extraction. The openings (41) are square, and are respectively configured on the relatively longer side of the periphery of the base body (4). Each opening (41) is formed through combination of symmetric notches (403, 423) configured on the periphery of the first housing (40) and the second housing (42).

The square and flat base body (4) is assembled as follows. On the periphery of the inner sides of the first housing (40) and the second housing (42), the relative shorter sides are respectively configured with a concave-hole column (404) and a convex column (424) matching each other. Through the columns, the first housing (40) and the second housing (42) can be locked together to form a square and flat base body (4); Moreover, the structures of the first housing (40) and the second housing (42) can be exchanged.

As needed, the above mentioned multiple housing spaces (402, 422) inside the base body (4) can be respectively placed with bar-shaped self-adhesive film notepaper sets (2), which respectively corresponds to the openings (41) on the longer sides of the periphery of the base body (4) for extraction. The central housing spaces (402, 422) can hold spare bar-shaped self-adhesive film notepaper sets (2) for future use.

In addition, a shallow gap (43) is specially configured at a position on the periphery of the first housing (40) or the second housing (42) of the square and flat base body (4) without the notches (403, 423); Thus, when the self-adhesive film notepaper set (2) is used up, the user can use his fingers of both hands to easily separate the base body from the shallow gap (43), and quickly replace or replenish the self-adhesive film notepaper set (2).

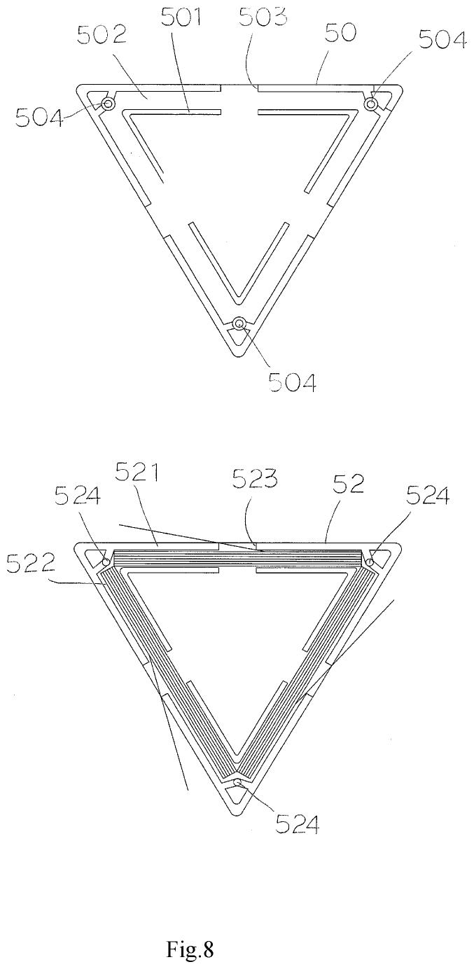

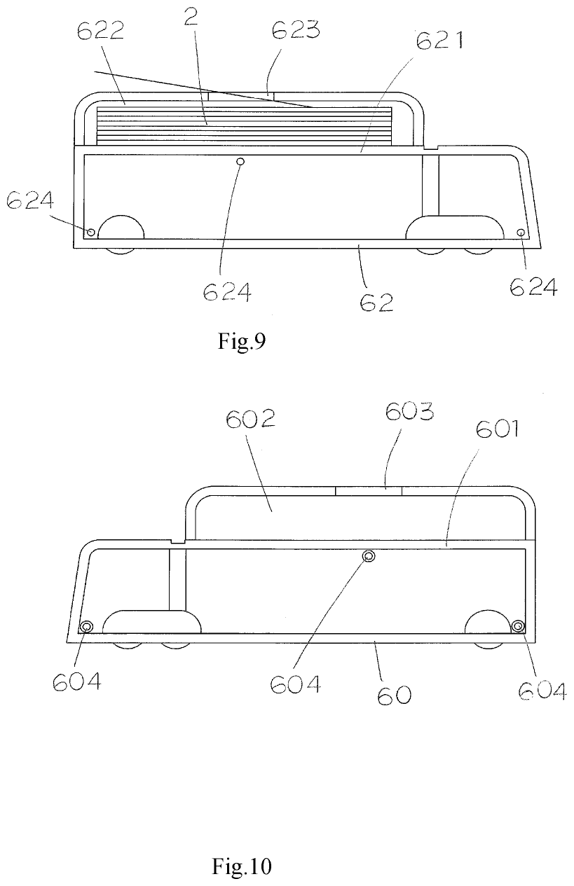

Referring to FIGS. 8˜9, a further embodiment of a triangular and flat self-adhesive film notepaper holder of the present invention is disclosed. It appears to be a triangular and flat base body (5), made up of a first housing (50) and a second housing (52) which are transparent or opaque, and are symmetric to each other. The inside of the first housing (50) and the second housing (52) are both partitioned into multiple housing spaces (502, 522) through separating walls (501, 521), to fit multiple sets of bar-shaped self-adhesive film notepaper (2). Each set of bar-shaped self-adhesive film notepaper (2) respectively corresponds to an opening (51) for extraction. The openings (51) are square, respectively configured on the periphery of the triangular and flat base body (5). Each opening (51) is formed through combination of the symmetric notches (503, 523) configured on the periphery of the first housing (50) and the second housing (52).

The triangular and flat base body (5) is assembled as follows. On the periphery of the inner sides of the first housing (50) and the second housing (52), the corners are respectively configured with a concave-hole column (504) and a convex column (524) matching each other. Through the columns, the first housing (50) and the second housing (52) can be locked together to form a triangular and flat base body (5); Moreover, the structures of the first housing (50) and the second housing (52) can be exchanged.

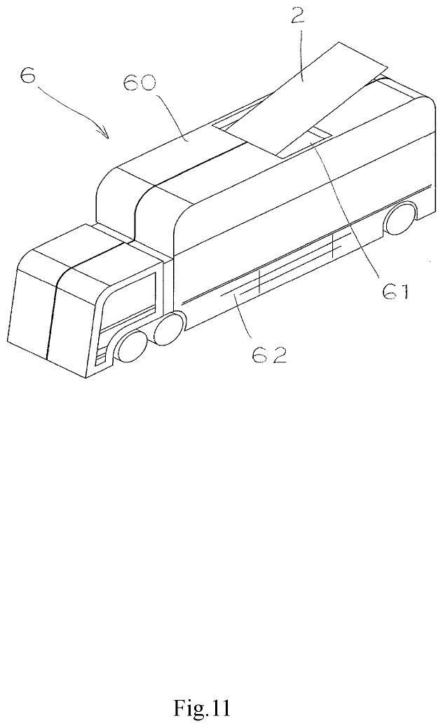

Referring to FIGS. 10˜11, a further embodiment of a vehicle-shaped self-adhesive film notepaper holder of the present invention is disclosed. It appears to be a vehicle-shaped base body (6), made up of a first housing (60) and a second housing (62) in the shape of a vehicle, being transparent or opaque, and symmetric to each other. The inside of the first housing (60) and the second housing (62) are both partitioned into multiple housing spaces (602, 622) through separating walls (601, 621), to fit a set of bar-shaped self-adhesive film notepaper (2). The set of bar-shaped self-adhesive film notepaper (2) corresponds to an opening (61) for extraction. The opening (61) is square, configured on the periphery of the base body (6) (as the position of the vehicle roof). The opening (61) is formed through combination of the symmetric notches (603, 623) configured on the periphery of the first housing (60) and the second housing (52).

The vehicle-shaped base body (6) is assembled as follows. On the periphery of the inner sides of the first housing (60) and the second housing (62), the triangular corners are respectively configured with a concave-hole column (604) and a convex column (624) matching each other. Through the columns, the first housing (60) and the second housing (62) can be locked together to form a vehicle-shaped base body (6); Moreover, the structures of the first housing (60) and the second housing (62) can be exchanged.

In the 4 types of embodiments of self-adhesive film notepaper holders of the present invention introduced above, the base body appears to be round and flat, square and flat, triangular and flat, and vehicle-shaped respectively. Apart from novel designs, they can be conveniently carried or placed on the desktop, and can be filled with different types of self-adhesive film notepaper sets. After one piece of notepaper is pulled out, the next piece will be brought out and exposed outside the base body for continuous usage. When the self-adhesive film notepaper set is used up, the user can easily use his fingers of both hands to separate the base body from the shallow gaps configured on the periphery of the base body, and quickly replace or replenish the self-adhesive film notepaper set. Then, the first housing and the second housing can be combined again to form a base body for continuous usage.

The embodiments described above are just preferred embodiments of the present invention, and are not intending to limit the scope of the present invention. All simple and equivalent changes or modifications based on the claims or descriptions of the present invention are still covered by the scope of the present invention.

1. A self-adhesive film notepaper holder, which is a flat base body made up of a first housing and a second housing of symmetric appearance; the relative inner sides of the periphery of the first housing and the second housing are respectively configured with matching concave-hole columns and convex columns to form a base body; the inner sides of the first housing and the second housing are both separated into multiple housing spaces using separating walls, for holding multiple sets of self-adhesive film notepaper, which can be respectively drawn out from multiple openings on the periphery of the base body.

2. The self-adhesive film notepaper holder defined in claim 1, wherein said first housing and second housing make up a round and flat base body.

3. The self-adhesive film notepaper holder defined in claim 1, wherein said first housing and second housing make up a square and flat base body.

4. The self-adhesive film notepaper holder defined in claim 1, wherein said first housing and second housing make up a triangular and flat base body.

5. The self-adhesive film notepaper holder defined in claim 1, wherein said first housing and second housing make up a vehicle-shaped base body.
